(19) United States
(12) Patent Application Publication
(10) Pub. No.: US 2020/0012958 A1
(43) Pub. Date: Jan. 9, 2020

(54) SYSTEM AND METHOD FOR REAL-TIME GENERATION OF PREDICTIVE MODELS OF MOBILE USERS' BEHAVIOR

(71) Applicant: APPNEXT LTD., Bnei-Brak (IL)

(72) Inventors: Elad NATANSON, Bnei-Brak (IL); Eran KARITI, Bnei-Brak (IL); Carmal ZIMRONI, Bnei-Brak (IL)

(73) Assignee: APPNEXT LTD., Bnei-Brak (IL)

(21) Appl. No.: 16/487,855

(22) PCT Filed: Feb. 22, 2018
(86) PCT No.: PCT/IB2018/051110

§ 371 Date: Aug. 22, 2019

Related U.S. Application Data
(60) Provisional application No. 62/461,812, filed on Feb. 22, 2017.

(51) Int. Cl. G06N 5/04; G06Q 30/02

(52) U.S. Cl. CPC G06N 5/046; G06N 20/00; G06Q 30/0241

(57) ABSTRACT

A method for performing at least one action on a user's computing-device, according to at least one user-moment, in-cluding: collecting data comprising at least one signal from the computing-device; analyzing the collected data in real time, to determine occurrence of at least one user-moment; analyzing by the processor a plurality of user-moments, to predict at least one future user-moment, related to what a user is expected to do, need or want; receiving a list comprising at least one action that may be applied on the user's computing-device; receiving at least one rule, associating the at least one action with the at least one predicted user-moment; receiving at least one rule-condition, associated with the rule and the at least one predicted user-moment; and performing at least one applied-action on the user's computing-device, according to the applied-rule, if the at least one rule-condition is met.

### FIELD OF THE INVENTION

The present invention relates generally to generating predictive models. More specifically, the present invention relates to generating predictive models of mobile users' behavior, through real-time data collection and analysis.

### BACKGROUND OF THE INVENTION

Current predictive models, used for ad serving, are generated through analysis of users' offline profiles. Offline profiles typically include raw data and/or analyzed or processed data, for example, demographic information (e.g., age, gender, income level, marital status, ethnic group, sexual preference etc.) Offline profiles may further include advertisement (Ad) interaction history (e.g., which ads were viewed, clicked, which applications were installed etc.) Offline profiles may additionally include browsing history, applications usage and history, sites visited and purchase history. Predictive models may be used for creating users' profiles that may be used by advertisers or marketers to target users, e.g., select content to be provided to users based on their respective profiles.

However, current or known systems and methods fail to draw different conclusions in real-time based on dynamic access to data signals. For example, known systems and methods cannot identify current and future real-world behavior of mobile users.

### SUMMARY OF EMBODIMENT OF THE INVENTION

Embodiments of the present invention disclose a method for performing at least one applied-action on a user's computing-device, associated with a processor, according to at least one user-moment. According to some embodiments, the method includes the steps of: collecting by the processor data comprising at least one signal from the computing-device; sending the collected data to a server; evaluating the collected data by the server in real time, to determine occurrence of at least one user-moment; analyzing by the server a plurality of user-moments, to predict at least one future user-moment, related to what a user is expected to do, need or want; receiving by the server a list comprising at least one applied-action that may be applied on the user's computing-device; receiving by the server at least one applied-rule, associating the at least one applied-action with the at least one predicted user-moment; receiving by the server at least one rule-condition, associated with the applied-rule and the at least one predicted user-moment; and performing by the server the at least one applied-action on the user's computing-device, according to the applied-rule, if the at least one rule-condition is met.

According to some embodiments, the plurality of user-moments may originate from a plurality of user computing-devices. Analyzing the plurality of user-moments to predict at least one future user-moment may be performed by a server, associated with the plurality of computing-devices.

According to some embodiments, the method may further include analyzing the plurality of user-moments from a plurality of user computing-devices, to create at least one user-profile. The user-profile may be associated with at least one user's computing device, and may include a plurality of user-moments, of which at least one user-moment is a predicted user-moment. The user-profile may further include at least one indication related to the user's preferences.

According to some embodiments, the method may further include collecting by the processor data that includes a plurality of data-signals from the computing-device, where at least one data-signal is associated with a score, and evaluating the collected data by the processor to determine at least one user-moment by combining the data-signals according to the scores.

According to some embodiments, the method may further include: receiving at least one applied-action from a third-party, said applied-action is associated with a predefined profile; comparing at least one user's profile with the predefined profile; and performing the applied-action on the user's computing device when a match between the predefined profile and user-profile is found.

According to some embodiments, the method may further include: clustering a plurality of user-profiles in a cluster model; associating specific users with user-moments pertaining to user-profiles of other users within the same cluster; continuously adjusting at least one clustering model, based on data-signals received as feedback from at least one users' computing device; and adjusting at least one applied-rule according to the adjustment of the clustering model, to improve the user's responsiveness to applied-actions.

According to some embodiments, the applied-action on the user's computing device is selected from a list comprising at least one of: invoking a specific application; presenting a link to at least one web site; presenting a list of icons, comprising at least one icon associated with an application installed on the computing device; presenting a list of icons, comprising at least one icon associated with an application installed on an online application store; and presenting an advertisement.

According to some embodiments, the method may further include: acquiring by the server feedback information from at least one user's computing device, including at least one of: a history of user-moments, a history of the user's recorded interests, a history of a user's application usage, and a history of the user's preferences; analyzing the feedback data to determine the relevance of applied-actions from the list of applied-actions; performing an applied-action according to said determined relevance; and updating at least one of a profile, applied-rule, rule-condition and score respective of a user, according to said analysis.

According to some embodiments, the feedback information may include at least one of personal data relating to the user, and information relating to the user's device. According to some embodiments, updating the user's profile may be done according to feedback acquired from a plurality of users.

According to some embodiments, data associated with at least one user-moment may be sent from a computing-device to the server. The sending of data to the server may be triggered according to a predefined, identified user-moment event.

According to some embodiments, collecting of data on the user's computing-device is performed by at least one first Software Development Kit (SDK) module installed therein. According to some embodiments, evaluating the data on the user's computing-device to determine a user-moment is performed by at least one second SDK module installed therein. According to some embodiments, performing of at least one applied-action on the user's computing-device is performed by at least one third SDK module installed therein. According to some embodiments, at least two of the first, second and third SDKs may be the same SDKs.

According to some embodiments, at least one of first, second and third SDKs are integrated within a third-party application installed on the user's computing-device.

According to some embodiments, the third-party application may be a native mobile app, and may be associated with a plurality of applied-actions.

According to some embodiments, the third-party application may be configured to perform at least one of: receive from the third-party mobile application a selection of an applied-action of the plurality of applied-actions; receive from the third-party mobile application at least one creative asset; receive from the third-party mobile application at least one second rule-condition; and perform the selected applied-action on the computing-device according to at least one of: the applied-rule, the first rule-condition, the second rule-condition, and the at least one creative asset.

According to some embodiments, the at least one creative asset may be selected from a list comprising: an applied-action type, an applied-action icon, an applied-action action title, an applied-action banner, a predefined UI, a predefined UX, timing of presentation, order of presentation, and context of presentation.

According to some embodiments, a plurality of SDKs may be integrated within a respective plurality of applications installed on a computing device, where each SDK may be configured to collect data on the user's computing-device according to access permissions attributed to the respective application. The server may be configured to determine which SDK in the computing-device has access to what data and control each SDK's data signal collection accordingly.

According to some embodiments, the method may further include the steps of: associating by the server a plurality of third-party applications with one applied-action; counting by the server the number of applications that are associated with the applied-action; checking by the server for at least one mutual connection between applications that are associated with the applied-action; periodically crawling by the server an online application store, for analyzing the description of applications in the application store; finding by the server at least one additional application with similar connections according to the analysis; and presenting by the server on the computing device notifications for the additional application.

According to some embodiments, the method may further include: tagging by the server at least one element with a tag respective to at least one user-moment. The tagged element may be selected from a list including at least one of: an application, a product, media content, a link, and content of a web page. According to some embodiments, the method may further include determining an occurrence of the at least one user-moment and presenting on the user's computing device a list comprising at least one element that is tagged with the tag respective to the at least one user-moment.

According to some embodiments, the method may further include presenting to a user on a computing device at least one message in real time, according to the user's profile, and at least one user-moment.

Embodiments of the present invention disclose a system for performing at least one applied-action on a user's computing-device, according to at least one user-moment. According to some embodiments, the system may include: at least one non-transitory memory device, on which modules of instruction code are stored; a processor associated with the at least one non-transitory memory device and configured to execute said instruction code.

According to some embodiments, when executing of the instruction code, the processor may be further configured to: collect data comprising at least one signal from the computing-device; evaluate the collected data in real time, to determine occurrence of at least one user-moment; analyze a plurality of user-moments, to predict at least one future user-moment, related to what a user is expected to do, need or want; receive a list comprising at least one applied-action that may be applied on the user's computing-device; receive at least one applied-rule, associating the at least one applied-action with the at least one predicted user-moment; receive at least one rule-condition, associated with the applied-rule and the at least one predicted user-moment; and perform the at least one applied-action on the user's computing-device, according to the applied-rule, if the at least one rule-condition is met.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flow diagram, elaborating a process of creating a user-profile, according to some embodiments;

FIG. 2 is a flow diagram, elaborating a process of performing applied-actions on a user's mobile device, according to some embodiments;

FIGS. 3A and 3B, jointly depict exemplary screenshots on a user's computing-device (e.g. a mobile device), according to some embodiments;

FIG. 4 shows a high-level block diagram of a system that includes a computing device according to some embodiments of the present invention;

FIG. 5 is a block diagram depicting modules within a server, according to some embodiments of the present invention;

FIG. 6 is a graphical illustration of a timeline and including a plurality of MOs according to some embodiments of the present invention;

FIG. 7A and FIG. 7B, jointly present an example for using predictive MOs, to suggest relevant applications to a user, prior to the time the user might need them, according to some embodiments;

FIG. 8 depicts an example of a list of tagged elements, as presented on a user's computing device, according to some embodiments; and

FIG. 9, depicting a flow diagram of a method for performing at least one applied-action on a user's computing-device, associated with a processor, according to at least one user-moment, according to some embodiments

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The following table provides a summary of the terms, as used henceforth throughout this document, and respective explanations for a reader's convenience. It should be noted that the definitions provided below are further to the regular definition of these terms as regularly used in the art.

| Term | Explanation |
|---|---|
| User | A user of a computing device (e.g. a mobile device, a smartphone, a |
| | tablet computer, a laptop computer and the like). |
| User-action | The term user-action is used herein to refer to at least one of: |
| | a user's behavior or action in the real world (e.g.: user is |
| | walking into a shopping-mall); and |
| | a user's action or behavior on their computing device (e.g.: |
| | user is taking a picture, or plugged in earphones on their |
| | smartphone) |
| User-moment | The term user-moment is used herein to refer to at least one of |
| | a user-action; |
| | a condition or a change of a condition of a user's computing |
| | device (e.g.: mobile device is connecting to a Wi-Fi network); |
| | the context of such user-action or condition in the real-world |
| | (e.g.: location where user is walking); and |
| | the context of a user-action in the real-world, or on the |
| | computing device (e.g.: user ordered food while playing an |
| | online game). |
| Predicted user-moment | A user-moment produced by analyzing at least one user-moment in |
| | at least one timeline and is associated with a predicted user-action. |
| Data-signal | Data acquired from a computing device (e.g.: user has clicked the |
| | ‘shoot’ button on the camera application on their cellular phone or |
| | tablet) |
| Moment-rule | An association of at least one data-signal with a user-moment (e.g. a |
| | user's computing device has connected to the user's home Wifi |
| | network may indicate that the user is currently at home). |
| Publisher | A producer of a mobile application |
| Advertiser | An entity (e.g.: an individual or a company), which provides a |
| | service, and requires the service to be advertised or accessed in any |
| | way via the publisher's application. |
| Applied-rule | An association of a user-moment with a possible applied-action that |
| | may be performed on the user's computing device. For example: the |
| | user may take a picture using a camera on his mobile device, an |
| | embodiment may identify at least one data-signal associated with the |
| | operation of the camera and determine that the user has taken a |
| | picture, and may perform an associated applied-action, e.g.: present |
| | a link for an image-processing application. |
| Rule | The term ‘rule’, in itself is used herein to commonly relate to both |
| | applied-rules and moment-rules. |
| Applied-action | An action that may be invoked or executed on a user's computing |
| | device (e.g.: invoking a mobile application, presenting an |
| | advertisement, presenting a link to a website, etc.) when an applied- |
| | rule is applied (e.g.: pop-up an advertisement when playing a specific |
| | game). |
| Rule-condition | A condition within the real world that may be applied to a rule and |
| | may determine the validity of the rule. e.g.: |
| | applying an applied-rule, to perform an applied action on a |
| | user's device at a specific time; and |
| | associating a data signal with a user-moment by a moment- |
| | rule, according to specific context. |
| Score | A weight that may be applied to a rule and may determine the |
| | relevance and/or certainty of the rule (e.g.: The user is now running, |
| | at a certainty of 80%). |
| Moment Object (MO) | A data object that may include data relating to at least one of a: data- |
| | signal, user-moment, timestamp, moment-rule, rule-condition, score, |
| | and applied-action. |
| Predictive MO | An MO that may be acquired through analysis of at least one historic |
| | user-moment (e.g. the user uses an app to order food every evening), |
| | to anticipate a user-moment in relation to future events (e.g.: the user |
| | is predicted to order food this evening). |
| Timeline | A collection of moment objects that may be associated with a single |
| | user and/or device. |
| User profile | A data object associated with a single user's computing device, |
| | including at least a timeline, indications related to at least one |
| | predicted user-moment, and indications related to the user's |
| | preferences. |
| SDK | Software Development Kit, including for example: a set of software |
| | modules (e.g. libraries) that enable acquisition of data from a mobile |
| | device, and/or performing applied-actions on the mobile device. |
| ASDK | Action Software Development Kit: an enhancement of SDK, which |
| | enables performing enhanced actions on the mobile device. |

Embodiments of the present invention disclose a system and a method for profiling a user of a computing device (e.g.: a smartphone, a laptop, etc.) according to the user's actions in the real world, receiving a list including at least one applied-action from a third-party advertiser, and executing at least one applied-action of the list of applied-action on the computing device, according to the user profile and according to at least one condition within the real world.

An embodiment may generate predictive models of mobile users' behavior, through real-time data collection and analysis. An embodiment may identify real-world user-moments in real time, through data gathering and analysis. An embodiment may create, and store information related to identified user-moments in a profile or in a timeline. For example, a moment object (MO) created by an embodiment may store or include a timestamp, moment-rules and rule-conditions as described herein and the MO may be included in, or associated with, a timeline.

An embodiment may generate a detailed timeline of a user by analyzing a user-moment, including active and passive engagement with his/her mobile device. An embodiment may create a user's timeline, in real-time, by identifying real-world moments the user experiences throughout the day. An embodiment may create, generate or define a user's timeline with MOs by analyzing data that's sent from, or received or generated by, the user's device.

An embodiment may use a timeline to predict the current, and future behavior of a user, even in cases in which the access to data is reduced. Output of some embodiments may be used by advertisers to target desired audiences based on their predicted behavior, thus increasing commercial conversion-rate levels significantly, and generating additional value to the end user.

Unlike known systems and methods, some embodiments of the invention may generate a consistently updating, detailed timeline for a user by analyzing the user's behavior in real-time. While known systems and methods might generate a timeline based on historical data, the timeline generated by known systems and methods is not consistently updated based on data that's collected and analyzed in real-time. In contrast, some embodiments may generate a timeline and consistently update or adjust it based on new data being sent from, or received by, a user's device. Additionally, some embodiments may predict what the user is about to do next, and the embodiments may further validate a prediction or assumption on the fly, in real-time.

An embodiment may associate a user with a specific group, specific set or specific audience of users. For example, based on a timeline, set of MOs or other information that associates (or matches) the user with a specific group, set or audience. An embodiment may associate a user with an audience or group independently. For example, based on real-time data and without relying on external data sources, an embodiment may adjust an association of a user based on real-time data, so media is not wasted on irrelevant traffic.

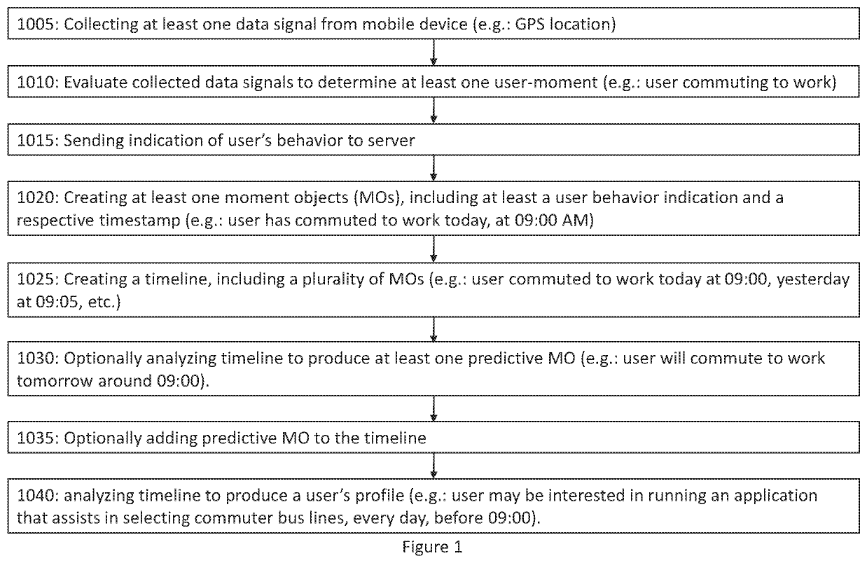

Reference is made to FIG. 1, showing a flow-diagram, elaborating a process of creating a user-profile, according to some embodiments, including the following steps:

According to some embodiments, the processor may be configured to collect at least one data-signal from a mobile device, that may be indicative of a user-moment, (S1005). For example, the processor may collect a positioning signal, according to a GPS application, indicating the location of a user in a specific moment in time.

Examples for data-signals that may be collected and analyzed by some embodiments include: connection to Bluetooth devices, and the type and identities of connected devices;

connection to a cellular network, including the type of network (e.g. 3G, 4G, etc.), carrier name, base station parameters, etc.; Wifi parameters, including whether the user's device is connected to a specific Wifi network, parameters of a connected network, parameters of identified Wifi networks, etc.; types and names of applications that the user is running on his device; the user's computing-device's operation system (OS), and OS version; the user's computing-device's language; parameters of the user's computing-device's storage, including type, capacity and free space; location of the user's computing-device (e.g.: country, city, etc.); parameters relating to the user's computing-device graphic processor, including its type and load; volume settings on the user's computing-device, including a ringtone volume, messaging volume, media playing volume, etc.; indication whether the device is connected to a charger; indications relating to the activity of the user's computing-device's camera; indication that an image that has been added to the device's storage; and indications relating to a user's state, e.g. whether the user is static, walking, running or riding a vehicle.

In some embodiments, the processor may apply at least one moment-rule on at least one data-signal, to identify and determine at least one user-moment (S1010). For example, the GPS location data-signal may be evaluated to determine that a user is currently commuting to work. According to some embodiments, an indication of the user-moment may be sent by the processor to a server (S1015). According to other embodiments, only the data-signal may be sent to the server, and the server may perform the analysis of the collected data-signal, to determine at least one user-moment.

The at least one user-moment may include, for example: an indication of a user-action in the real world; an indication of a user-action on a computing device, a change in a condition of the computing device, and information regarding the context of such user-actions or changes in condition. Embodiments may identify, and determine at least one user-action. Examples for user-actions include: listening to music; watching a movie; exercising; navigating, ordering food, being at a location (e.g. a restaurant), order a taxi, commuting (e.g.: using public transportation), playing a game, shopping online, shopping in a physical shop, etc.

According to some embodiments the server may receive a user-moment score, to determine the relevance and/or accuracy of at least one data-signal in identifying a specific user-moment.

The server may create at least one moment-object (MO), including at least a user-moment and a respective timestamp (S1020). For example, the server may create an MO, including a “user commuting now” user-moment and a 09:00 AM timestamp.

The server may create at least one timeline, including at least one MO (S1025). For example: user commuted to work today at 09:00, user commuted to work yesterday at 09:05, etc.

In some embodiments, the server may be configured to analyze the timeline, to produce at least one predictive MO (S1030) including at least one predicted, future user-moment. For example, the server may collect all previous user-moments in the time line (e.g. previous commuting events, the current location of the phone, etc.), and create a predictive MO, including a prediction that the user will commute to work tomorrow, around 09:00. The server may further be configured to attribute a score to the predictive MO, stating a probability and relevance of the predicted user-moment. For example, the server may attribute a score of 80% probability to the prediction that the user will commute to work tomorrow, around 09:00.

According to some embodiments, the server may add at least one predictive MO to the timeline (S1035). The at least one predictive MO may be included in further analysis of the timeline by the server, to iteratively create subsequent predictive MOs.

The server may analyze the timeline to produce a user's profile, including data respective of their user-moments, and preferences (S1040). This user profile may later be utilized by the server to target specific users for personalized advertisements and improving the advertisements conversion rate. Pertaining to the same example, the profile may include information regarding the schedules, locations, and preferences of the user's commute. The user may be marked as a potential customer for an application that may assists in commuting or may be presented an advertisement for a croissant on his way to work tomorrow, in a bakery near his bus-stop.

According to some embodiments, the server may accumulate a plurality of user-profiles, and apply a machine-learning (ML) algorithm on at least one ML clustering model, to produce a plurality of user-profile clusters, that are indicative of the users' user-actions and user-moments. The user-profile cluster may be used to associate specific users with additional user-moments, pertaining to other characteristics of other users within the same cluster. For example, a user may be profiled as a ‘commuter’, as explained in the above example. The ML model may associate the user's user-profile to a cluster of user-profiles that are characterized as commuters, but are also characterized as “Museum goers”. According to some embodiments, the server may consequently create a predictive user-moment, associated to the additional characteristic of the user's profile (e.g. “the user will be visiting a museum this weekend, in high probability), and create an applied-action, associated with the user's predicted user-moment (e.g.: the server may present on the user's device an offer for discounted tickets for a nearby museum).

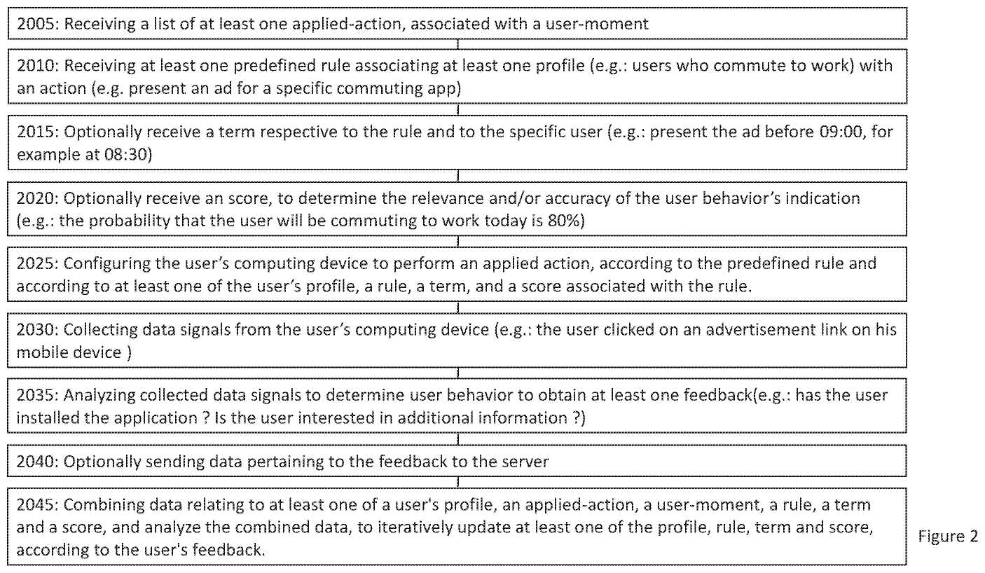

Reference is made to FIG. 2, showing a flow-diagram, elaborating a process of performing applied-actions on a user's mobile device, according to some embodiments, including the following steps:

The server may receive a list comprising at least one applied-action, that may be associated to at least one user-moment (S2005). For example, the applied-action may include presenting at least one icon of a mobile app, associated with a specific user-moment. Pertaining to the example of commuting-to-work, the server may present an icon, that serves as a link to advertise a mobile app, that is directed to assisting users in selecting commuter bus lines.

The server may receive at least one predefined applied-rule associating at least one profile with an applied-action (S2010). For example, users who are profiled as “commuters to work” may be associated by an applied-rule to an applied-action such as: presenting an icon for a commuting-assistant app installed on the user's mobile device; actively launching a predefined app on the user's mobile device; presenting an ad for a commuting-assistant app; opening a network browser on a relevant website, etc.

According to some embodiments, the server may receive a rule-condition respective to the at least one applied-rule and to the specific user profile (S2015). The rule-condition may apply restrictions or enhancements on the applied-rule, according to circumstances. In the commuting example, the profile may include information regarding the timing of the user's daily commute (e.g.: 09:00 AM), so the rule-condition may dictate association of the applied-action to the user-moment prior to that time. Consequently, the user may be presented an ad for a new shop that has been opened along the bus route, at 08:00 AM.

According to some embodiments, the server may receive a score, to determine the relevance and/or accuracy of at least one predictive MO (S2020). For example: a user may be predicted to commute today by bus, in a probability of 30%, or by train, in a probability of 50%. The higher probability of commuting by train may cause an embodiment to select an applied-rule associated with a train-related applied-action (e.g. present the trains time-tables) rather than the bus-related applied-action (e.g. present the bus selection application).

The server may configure the user's computing-device (e.g.: mobile phone) to perform an applied-action according to at least one of: the user's profile, an applied-rule, and a rule-condition and a score associated with the applied-rule (S2025). According to some embodiments, the applied-action may be configured and executed on the user's computing-device (e.g. mobile device) by a Software Development Kit (SDK) or Action Software Development Kit (ASDK) installed therein, as elaborated further below.

According to some embodiments, the processor may collect at least one data-signal from the user's mobile device, pertaining to the user's behavior following the execution of the applied-action (S2030). For example, if the applied-action included presenting an icon on the device screen that links to an installation of an application on an “app-store”, the processor may collect data-signals from the mobile device to determine whether the user has clicked the icon, browsed through a relevant website, installed the respective app, etc.

According to some embodiments, the processor may analyze the at least one data-signal, to obtain at least one feedback from the user following the execution of the applied-action (S2035) and may further send data pertaining to the feedback to the server (2040).

According to some embodiments, the collecting of the at least one data-signal from the user's mobile device, analysis of the at least one data-signal, obtaining the feedback and sending the feedback to the server may be performed by at least one SDK or ASDK, as elaborated below.

The server may combine data relating to at least one of a user's profile, an applied-action, user-feedback data, a user-moment, an applied-rule a rule-condition and a score, and analyze the combined data, to iteratively update at least one of the profile, applied-rule, rule-condition and score, according to the user's feedback, and improve the user's responsiveness to the applied-action (S2045).

According to some embodiments, the server may further be configured to continuously adjust the at least one ML clustering model, to improve the clustering of user-profiles, and produce and/or adjust at least one applied-rule according to the adjustment of the clustering model. The adjustment of at least one applied-rule may improve the association of applied-actions to specific user-profiles, and thus improve the user's responsiveness to applied-actions.

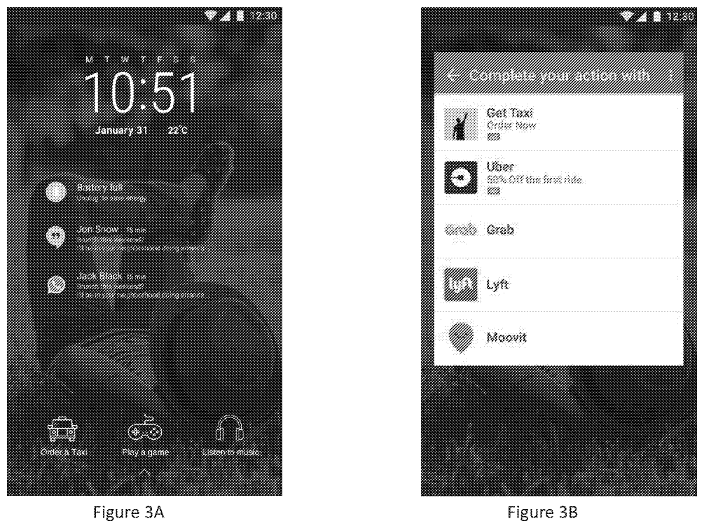

Reference is made to FIGS. 3A and 3B, depicting exemplary screenshots on a user's computing-device (e.g. a mobile device), according to some embodiments of the present invention. As shown on FIG. 3A, several applied-actions may be displayed to a user, at the bottom of a publisher's lock-screen app.

The applied-actions may be associated with, and presented due to identified user-moments. For example, the “Listen to music” icon may be presented due to a change in the user's computing-device's condition. (e.g. the user has plugged his headphones into his Smartphone's jack).

The applied-actions may be presented due to predicted user-moments. For example, the “order a taxi” icon may be presented on the screen according to a predictive MO, including a predicted user-moment, according to which the user will soon require the service of a taxi (e.g. at 11:00 AM).

According to some embodiments, the system may receive a predetermined profile from a third-party (e.g.: and advertiser) that is associated with at least one applied-action, compare the predefined profile with the user-profile on the user's computing device, and execute at least one applied-action on the user's computing device when a match is found. For example, the “Play a game” icon may be presented on the screen due to the game's publisher requirement, after matching the user's profile with a predefined profile of a gamer.

As shown in FIG. 3B, an embodiment may perform composite applied-actions on the user's computing-device. For example, after clicking a first action icon (e.g. the “Order a taxi” icon of FIG. 3A), a user may be prompted to complete the action by selecting one application from a list of relevant applications (e.g.: a list of apps relevant to an action of ordering a taxi).

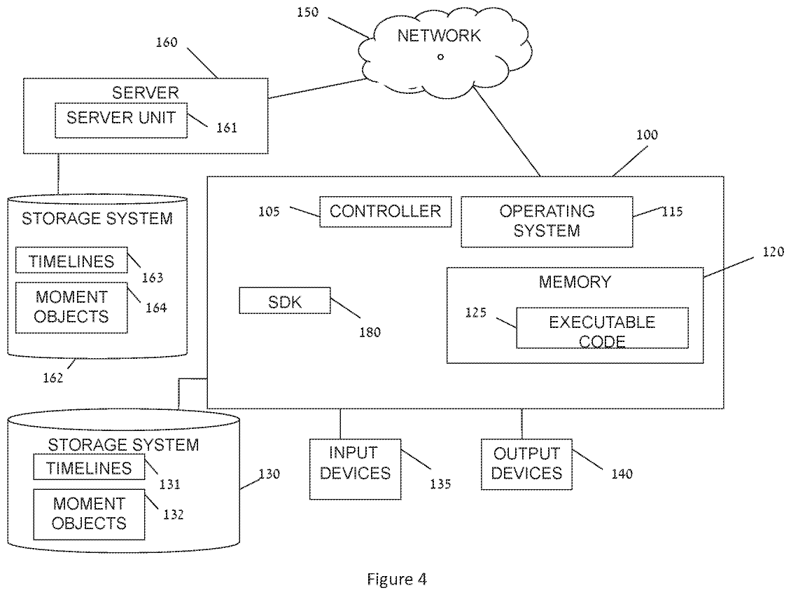

Reference is made to FIG. 4, showing a high-level block diagram of a system that includes computing device 100 according to some embodiments of the present invention. As shown, a system may include a server 160 that may include a server unit 161 and a system may include a network 150. Computing device 100 may be a user's device, for example, computing device 100 may be, or may be included in, a smartphone, a mobile device or mobile communication device, a tablet, a laptop or any other suitable user device.

Computing device 100 may include a controller 105 that may be, for example, a central processing unit processor (CPU), a chip or any suitable computing or computational device, an operating system 115, a memory 120, executable code 125, a storage system 130, input devices 135 and output devices 140. Controller 105 (or one or more controllers or processors, possibly across multiple units or devices) may be configured (e.g., by executing software or code) to carry out methods described herein, and/or to execute or act as the various modules, units, etc. More than one computing device 100 may be included in, and one or more computing devices 100 may be, or act as the components of, a system according to some embodiments of the invention.

More than one computing device 100 may be included, and one or more computing devices 100 may act as the various components. For example, although a single computing device 100 is shown in FIG. 1, a system according to some embodiments may include hundreds of thousands computing devices 100, e.g., server 160 may communicate with a very large number of smartphones.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or enabling software programs or other modules or units to communicate. Operating system 115 may be a commercial operating system, e.g., Android or iOS.

Memory 120 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be any executable code, e.g., an application (app), a program, a process, task or script. Executable code 125 may be executed by controller 105 possibly under control of operating system 115. For example, executable code 125 may be an application that defines, creates or generates Moment Objects (MOs) and/or timelines as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein, e.g., a data collection unit, a data storage unit, a data analysis unit and a timeline generation unit may be, or may include, controller 105, memory 120 and executable code 125.

Storage system 130 may be or may include, for example, flash memory, an external or internal hard disk drive, a CD-Recordable (CD-R) drive, a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile and/or flash memory having the storage capacity of storage system 130. Accordingly, although shown as a separate component, storage system 130 may be embedded or included in memory 120.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or monitors, speakers and/or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, (I/O) devices 135 and 140 may include a wireless network interface component (e.g., a WiFi system or component), a Bluetooth component and the like.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, cellular or smart phone, a personal computer, a laptop computer, a server computer, a network device, or any other suitable computing device.

Network 150 may be, may comprise or may be part of a private or public IP network, or the internet, or a combination thereof Additionally, or alternatively, network 150 may be, comprise or be part of a global system for mobile communications (GSM) network. For example, network 150 may include or comprise an IP network such as the internet, a GSM related network and any equipment for bridging or otherwise connecting such networks as known in the art. In addition, network 150 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 150 are implied but not shown, e.g., access points, base stations, communication satellites, GPS satellites, routers, telephone switches, etc. It will be recognized that embodiments of the invention are not limited by the nature of network 150.

Software development kit (SDK) 180 may be, or may be included in, executable code 125. For example, SDK 180 may be a software application (app), executed by controller 105, and designed to create timelines and MOs as described herein. Server unit 161 may be, or may be included in, executable code 125 in server 160. For example, server unit 161 may be a software application, executed by controller 105 in server 160, and designed to communicate with a plurality of computing device 100 and create timelines and MOs as described herein.

As shown, storage system 130 may include timelines 131 and MOs 132. As shown, storage 162 may include timelines 163 and MOs 164. For example, SDK 180 may generate, update and/or receive timelines 131 and MOs 132 and server unit 161 may generate, update and/or receive timelines 163 and MOs 164 as further described herein.

In some embodiments, generating and using predictive profiles, timelines and MOs may be accomplished using several units or layers, for example, an embodiment may include a data collection unit or layer, a data storage unit or layer, a data analysis unit or layer and a serving unit or layer.

In some embodiments, data collection may be performed by SDKs 180 installed in a plurality of user's computing-devices (e.g.: millions of mobile devices). The SDK 180 may be either integrated into applications (e.g.: hybrid mobile apps, native mobile apps) or installed within the computing-device 100 as separate software modules. In some embodiments, SDK 180 may include a data library module that collects signals from device 100. Determining a user-moment (e.g.: a user-action and/or a condition of the user's device) may be based on a plurality of data-signals. For example, based on input from a global positioning system (GPS) included in device 100, SDK may determine whether a user is walking or driving. In another example, according to input from the device's operating system (OS, 115), SDK 180 may determine what application a user is currently using.

In some embodiments, a data analysis unit may analyze collected data, e.g., an analysis result may be, or may be used to determine a definitive conclusion, for example: a user's behavior may be determined based on analysis of collected data, e.g., whether or not a user is idle, walking, running, driving or riding a bicycle. An indication of the user's behavior may be sent (e.g., by SDK 180) to server 160.

In some embodiments, data collected by SDK 180 may be analyzed, by SDK 180, immediately or in in real time, e.g., to identify and create MOs and/or to update a profile. In some embodiments, data collected and sent by SDK 180 to server 160 may be analyzed immediately, in real time, by server 160 e.g., to identify and create MOs.

In some embodiments, the server may be associated with the plurality of computing-devices, and may receive a plurality of user-moments, originating from the plurality of computing-devices. The server may analyze the plurality of user-moments to predict at least one future user-moment, and create at least one respective MO.

In some embodiments, server 160 may update SDK 180 in real time, for example, upon identifying data included in an MO as described, server 160 may update SDK 180, e.g., server 160 may send an MO to SDK 180 and, based on the received MO, SDK may perform one or more actions as described herein.

In some embodiments, sending data to server 160 may be event or trigger based, e.g. following identification of a user-moment by SDK 180, or at a predefined period. For example, data may be sent following a change in the computing device's condition (e.g.: when device 100 is connected or disconnected from WIFI, the state logged and is sent, by SDK 180, to server 160).

In another example, data associated with at least one user-moment may be sent by SDK 180 to the server, triggered by the identification of at least one predefined, identified user-moment event associated with at least one user-action (e.g.: when the user is identified as riding a bicycle). In some embodiments, configurations or cases, collected data may be sent to server 160 regularly, in a raw state, in pre-defined intervals. For example, information related to nearby WIFI networks, may be sent as raw data to server 160 at a per-set interval. Raw data sent to server 160 may be analyzed, by server 160, in real-time once received.

Configuration data may be downloaded from server 160 to SDK 180, e.g., at predefined intervals or times. Configuration data, information or file received from server 160 may include any settings and/or logic for data collection and retrievals. For example, SDK 180 may collect specific data at specific times or intervals (e.g., determine user location every hour, identify applications used in real-time and so on) based on settings in a configuration received from server 160.

In some embodiments, SDK 180 may be integrated into a host application, and may thus gain access to the data permissions the application received from the user. In some embodiments, SDK 180 may “ride” the host application's permissions to gain access to user data. In some embodiments, a plurality of SDKs 180 may be included in computing device 100, e.g., a first and a second SDK's 180 may be integrated in a respective first and second applications on computing device 100. In case the SDK 180 is integrated in more than one application on the device, SDK 180 may use the different permissions from each application in a way that maximizes the access to user data. Server 160 may be adapted to identify, determine or know which SDK 180 in computing device 100 has access to which data, and may control each of the SDKs 180, e.g., turn off and on data signal collection in each SDK 180, for example, according to data collection by other SDK's 180 on computing device 100. Any other operation of SDK 180 may be controlled by server 160 such that server 160 may fully control which signals are collected, from each individual device, which signals are processed on the device, which are monitored and which are sent in a set interval. For example, configuration downloaded to SDK 180 as described and real-time control (e.g., using a network communication channel as known in the art), server 160 may fully and in real-time control operations and functions of any number of SDKs 180.

Timelines, MOs and collected data may be stored using any suitable, possibly commercial system or platform. For example, data may be stored or hosted on Amazon, in system query language (sq1) and/or none-sq1 forms. In some embodiments, server 160 may use Cassandra storage architecture such that it may support massive scaling according to the amount of data sent by the SDK's 180. Although a single server 160 is shown in FIG. 1, any number of servers 160 may collaborate in receiving and processing data as described. Accordingly, server 160's architecture may handle surges of traffic, without losing any data, and it may be adapted for running real-time analysis on every data signal stored per each user, including making a comparison to all data previously stored in a user's profile.

A user profile may include or may be updated according to, a timeline and one or more MOs. Accordingly, a user profile may include indications of user-actions, timing of user-actions, and indications or information related to what a user is expected to do, need or want (e.g.: predicted user-moments). For example, based on a timeline and MOs in a user profile, an embodiment may know or determine that the user will want (or order) a pizza every Tuesday evening, order a taxi every morning at 08:15 and so on.

A profile, timeline and set of MOs of a user may be associated or linked to a computing device. For example, SDKs 180 and server 160 may store data (e.g., raw data, profile, timeline and set of MOs) in association with a device identification code or number (ID), e.g., a profile, timeline and set of MOs of a user may be associated with an Advertising Identifier (IDFA) that is a unique ID for iOS devices.

In some embodiments, each user-profile may include a current-MO, reflecting the state of a respective user in the real world, as well as historic data that was used to form the current-MO. According to some embodiments, server 160 may be configured to change the current-MO upon reception of at least one additional data-signal sent by SDK 180. According to some embodiments, server 160 may be configured to process the at least one additional data-signal along with previous data to identify a user-moment and determine an associated moment-rule.

For example, in some embodiments, each profile may be associated with a snapshot, describing the user (reflective state) and this snapshot may be updated according to incoming data and reached conclusions. In addition, each profile may include a complete history of raw data and conclusions reached through analysis, that when analyzed, with or without additional data, might change the reflective state.

According to some embodiments, the server may be configured to change at least one existing MO upon reception of at least one additional incoming data-signal. According to additional embodiments, the server may be configured to store the at least one additional data-signal, and analyze the data-signal together with other, previously received data-signals, or with data-signals that may be expected to be received later.

Every moment-rule and rule-condition may be considered according to other rule-conditions in a user-profile. For example, the server may be configured to identify a specific user-moment, and select a specific moment-rule based on at least one incoming data-signal, or await the reception of additional data-signals before reaching a conclusion, according to at least one score. In another example, a moment-rule may be selected from a plurality of moment-rules by comparing the strength of the rule-conditions that make each moment-rule, in order to choose the most definitive conclusion.

The following table presents examples for determining user-moments, based on respective rules and rule-conditions, according to some embodiments:

| User-moment | Logic | Rule | Rule-condition |
|---|---|---|---|
| User is at | Server 160 may be | After an initial learning | If multiple home Wifi |
| home | configured to conclude | period, each time a Wifi | connection events |
| | that a user is home by | signal that his categorized | appear in a row, ignore |
| | analyzing the user's | as the home network | events that are not |
| | Wifi signals around his | appears in the Wifi list - it | preceded by an exit |
| | home. | means that user is home | event |
| User is | Server 160 may be | If the user's location for | If the location has |
| abroad on a | configured to conclude | the past 5 days is different | changed within a period |
| vacation | that a user is abroad on a | than the user's location | of 5 days, the day count |
| | vacation, according to | prior to that time, the user | should be restarted. |
| | their location in the past | will be considered abroad | |
| | 5 days. | for vacation. | |

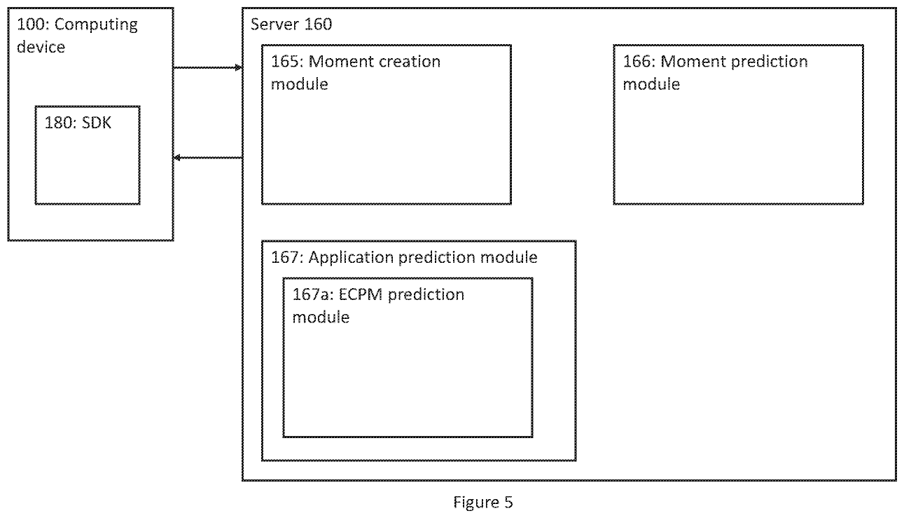

Reference is made to FIG. 5, which is a block diagram, depicting modules within the server, according to some embodiments of the present invention. As elaborated above, server 160 may be configured to: receive at least one data-signal from at least one SDK 180 within at least one user's computing device 100; analyze the data-signal to identify at least one user-moment; predict at least one future user-moment; associate at least one user-moment with at least one applied-action; and configure at least one SDK 180 on the at least one user's computing device 100 to perform the applied-action on the user's computing device 100.

As depicted in embodiment of FIG. 5, server 160 may include at least one of: a moment creation module 165, a moment prediction module 166, and an application-prediction module 167. The application-prediction module 167 may further include an effective cost per mille (ECPM) prediction module 167a.

According to some embodiments, moment creation module 165 may be configured to receive data-signals from computing device 100 and apply a machine learning (ML) algorithm on at least one ML model determine at least one current user-moment. According to some embodiments, moment creation module 165 may enable an administrator user to present at least one rule, for determining at least one user-moment according to the received data-signals (e.g. by classifying at least one data-signal as associated with at least one user-action).

Moment creation module 165 may further be configured to create new models based on collected data-signals, and perform machine learning algorithms to update the models based on at least one feedback from the user. According to some embodiments, moment creation module 165 may include at least one ML clustering model, configured to produce a plurality of user-profile clusters, that are indicative of the users' user-actions and user-moments. User-profile clusters may be used to associate specific users with additional user-moments, pertaining to other characteristics of other users within the same cluster. According to some embodiments, moment creation module 165 may further be configured to continuously adjust at least one ML clustering model, based on data-signals received as feedback from users' computing devices, to improve the clustering of user-profiles. The continuous adjustment of clustering enables the server to improve the user's responsiveness to applied-actions, by fine-tuning the applied-rules, and improving the association of specific user-profiles to applied-actions.

According to some embodiments moment prediction module 166 may be configured to predict future user-moments based on stored, historical user-moments. For example, after learning a user's behavioral patterns, associated with at least one user-action (e.g.: arrival at home, arrival at work, listening to music at specific hours, ordering a taxi each morning, etc.) moment prediction module 166 may predict future user-moments for that user. This prediction may facilitate performing applied-actions on the computing device (e.g. presenting relevant content) before the predicted moment occurs. According to some embodiments, the prediction may be calculated based on daily and weekly behavioral patterns of the user.

According to some embodiments, application-prediction module 167 may be configured to: receive from SDK 180 indications of the applications that are installed and used on computing device 100; receive at least one user-profile, including at least one user-moment from moment creation module 165. Application-prediction module 167 may include an ML model, configured to classify applications according to application-profiles, based on the received data. Server 160 may be configured to utilize the application-profiles, to crawl through application stores and associate specific applications with potential users, according to application-profiles and user-profiles.

According to some embodiments, application-prediction module 167 may further include an ECPM prediction module 167a, configured to improve user engagement with specific applications and advertisements, and serve the most relevant advertisements with the highest yields.

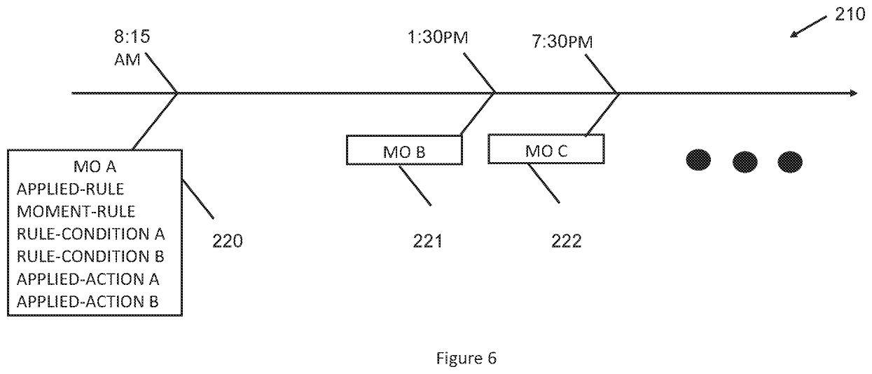

Reference is made to FIG. 6, which is a graphical illustration of a timeline and MOs according to some embodiments of the present invention.

In some embodiments, MOs may relate the user's behavior in relation to the real-world user-actions, and to the real-world context (e.g.: timing, concurrent real-world events, concurrent events on the user's mobile device, etc.) of that behavior. In some embodiments, user behavior may relate to current user-actions (e.g.: ordering food, calling a taxi etc.) and/or to predicted actions of a user (e.g. predicting that a user will call a taxi at a specific time in the future).

As shown by MO 220, an MO may include at least one of: a moment-rule, an applied-rule, a rule-condition (e.g., rule-condition A and rule-condition B) and a applied-action (e.g.: invoke application A and application B). It is noted that any number of rules, rule-conditions and applied-actions may be included in, pointed or referenced by, or associated with, an MO. In some embodiments, each moment-rule may be met when or if one or more of the rule's rule-conditions apply or match an input. Rules in an MO may be the starting point for an algorithm or logic that may reach conclusions about the user's behavior and/or moments on the timeline.

A rule-condition may include data of various types and formats. For example, a rule-condition may include, or be a combination of data types such as raw data, processed data, device state data, enriched data, historical data, and historical conclusions. A set of rule-conditions that match an input data-signal may define which moment-rule is met, executed or applied.

In some embodiments, at least one moment-rule in an MO may be attributed a score for determining the strength of the conclusion, based on the data they rely on. For example, there may be strong rule-condition and weak rule-conditions, depending on the data quality and volume present, used to fill the rule-condition.

For example, an MO may include several moment-rules where each may be a combination of new, prior, or current data, circumstances or past conclusions. Each variable in an MO or profile may be assigned with a score, and the entire index of a moment-rule may be a combination of these scores. Rules may have their own score based on the winning rule-condition and data-signal score, used to meet the rule, combined with a predefined index. According to some embodiments, moment-rules may be compared among each other in order to generate conclusion and identify a user-moment with the highest probability.

Generally, a data-signal may be associated with a score as described above. rule-condition moment-rules and applied-rules may also be associated with a score that relates to a plurality of data-signal scores, and/or pre-set factors. For example, a user may go out for jogging, and may use a smartphone to hear music during his jog. The user-device may produce a data-signal relating to the user's location (e.g.: GPS location), and another data signal relating to the plugging of headphones in the smartphone. The server may be configured to combine the data-signals, and accumulate the scores associated with the two data-signals (e.g. sum the scores with respective pre-set factors), to evaluate the collected data, and ascertain a high probability that the user is listening to music while jogging. The server may further be configured to perform an applied action according to the determined user-moment, based on at least one applied-rule. For example: the server may present on the user's device an advertisement for an application dedicated to work-out music.

In some embodiments, when a rule-condition is fulfilled, a moment-rule may be applied, and an MO may be generated and logged for the user. For example, the MO may be stored as part of the user's user-profile.

In some embodiments, MOs may be defined within a specific scope. For example, MOs may have a predefined expiration time, and may also expire prior to that based on other MOs logged for the user or based on incoming data.

As shown, MOs 220, 221 and 222 may be associated or linked with a timeline 210. For example, an MO may include a timestamp thus linking or associated the MO with a timeline. For example, MO A 220 may be associated with 8:15 in the morning (e.g., a moment a user calls a cab), MO B 221 may be linked or associated with a moment or time the user typically orders lunch using his phone and MO C 222 may be created based on identifying that the user watches a game or has dinner in the evening. For the sake of clarity, data included in an MO is only shown for MO A 220. It will be understood that other methods of storing data related to moments as described herein may be used and that MOs as described herein are a simplified example, thus, it is recognized that the scope of the invention is not limited by the method or way data related to moments is stored and/or associated with a timeline.

Some of MOs 220, 221 and 222 may be generated as described and may reflect real-time aspects and some of MOs 220, 221 and 222 may be predictive, e.g., at 9:20 AM, MO B 221 may be related to a predicted moment, e.g., predicting that the user will have lunch at 1:30 PM.

In some embodiments, predicted MOs for a user may be automatically generated (e.g., by server 160 and/or by SDK 180) based on historical moments (or MOs) logged for the user. If for example, a user is logged with an MO for “ordering a taxi” every morning when he leaves his home on his way to work, server 160 may log, generate or create a predictive MO which predicts the moment the user is about to experience.

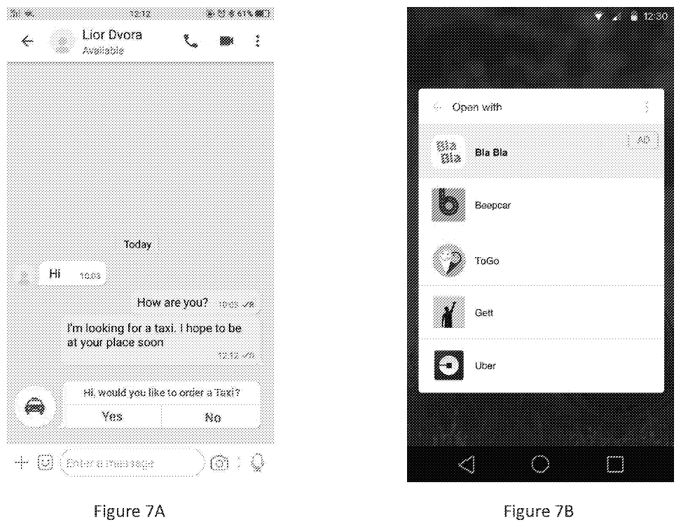

According to some embodiments, server 160 may use predictive MOs to suggest relevant applications to a user, prior to the time the user might need them (right when he's about to use or need to use the applications). For example, based on a predictive MO related to lunch (e.g., MO B 221) and based on an action in the MO (e.g., action A in MO A 220 may include executing a specific application on the user's cellphone), SDK 180 may launch or activate an application used for ordering lunch, on the user's smartphone. Reference is made to FIG. 7A and FIG. 7B, jointly presenting another example for using predictive MOs, to suggest relevant applications to a user, prior to the time the user might need them, according to some embodiments. A user may discuss a requirement for a taxi during a chat, as depicted in FIG. 7A. An embodiment may be configured to collect a data-signal associated with this requirement. In this example, the data-signal may be an identification of the word ‘Taxi’. An embodiment may produce a predicted MO, including a predicted “require taxi” user-moment, indicating that the user will soon require the services of a taxi. The predictive “require taxi” user-moment may be associated with an applied-action configured to prompt a query within the chat application, asking the user whether they actually need the service of a taxi company at the present moment, as also depicted in FIG. 7A. The applied-action may be further configured to present a predefined list of relevant companies as depicted in FIG. 7B, following assertion by the user that they actually do require such a service.

According to some embodiments performing applied-actions on the user's computing device is selected from a list including, for example: invoking a specific application; presenting a link to at least one web site; presenting a list of icons, comprising at least one icon associated with an application installed on the computing device; presenting a list of icons, comprising at least one icon associated with an application installed on an online application store; and presenting an advertisement.

In some embodiments, predictive MOs may be post-validated, e.g., after performing an action or predicting something a user will do or want, SDK 180 may check whether or not a prediction related to (or included in) an MO was correct. If a prediction is found to be correct, a score for the related MO may be increased, if a prediction is found to be wrong, a score of the MO may be decreased, or the MO may be deleted.

According to some embodiments, the server may be configured to validate MOs in a number of ways. For example, third-party data may be used to validate raw data collected and/or to validate user MO's generated as described. In some embodiments, machine learning may be used to train an algorithm, or update logic, by validating predictive and real-time MOs, e.g., using testing applications operated by employees. In some embodiments, programmatic training of a system may include measuring the impact of suggesting users with specifically handpicked applications, relevant to specific moments and making auto corrections, e.g., an embodiment may automatically correct, modify or update rules in at least one MO.

As described, an applied-action associated with (or indicated in) an MO may be performed. For example, when an MO is generated or when the time of a predictive MO arrives, server 160 and/or SDK 180 may, as part of an action performed, suggest the user to use applications that are found relevant to the moment or time of the MO.

In some embodiments, an applied-action may be selected to be performed on the user's computing device from a list of applied-actions. For example, an embodiment may determine which applied-action is most appropriate (e.g.: which applications to suggest to a user) according to their relevance to the user's profile.

According to some embodiments, the server may acquire feedback information from the user's computing device, to determine the relevance of an applied-action (e.g.: invoking a specific application) to a user-moment or MO. The feedback information may include, for example: a history of user-actions (e.g. the user-moments), a history of the user's recorded interests (e.g.: user's browsing history), a history of a user's application usage, the user's preferences in relation to presented choices (e.g.: a user's selection of an application from a list of presented applications), data relating to the personal user data (e.g.: location, demographic information, age, gender, etc.) and information relating to the user's device (e.g.: brand, model, operating system, etc.). According to some embodiment, the server may further analyze the feedback data to update at least one user's profile, timeline and/or MO.

Specifically, user-moments and user-moment history (e.g., logged in or in association with MOs) may be a major part of the decision making of an algorithm or logic. For example, machine learning may be applied to find a direct connection between users, with similar data characteristics, who share similar user-moments, and their applications preferences (e.g., which applications they choose to use or install when experiencing the same moments).

Relevance of applications automatically launched or executed as described may be defined or chosen by advertisers. For example, server 160 may provide an advertiser who wants to target users who take a taxi in the morning with a list of users who match this criterion. For example, server 160 may analyze MOs of many users and select the ones matching a preference of an advertiser. An advertiser may request (e.g., in a message sent to server 160) a specific application to be executed on a user's device, e.g., at a specific time or when the user is actively involved in a specific activity. An advertiser may request a specific content (e.g., an advertisement in a web browser) to be presented to the user, e.g., at a specific time or when the user is actively involved in a specific activity.

As described, an MO may include, or be associated with, one or more actions (e.g., action A and action B as shown in FIG. 2). Applications (e.g., applications installed on a smartphone or computer as known in the art) may be matched or associated with moments by matching or associating then with MOs, e.g., as shown by applications A and B in MO 220. Otherwise described, an MO may have one or more applications associated with it.

Accordingly, an embodiment may associate or map actions and applications to moments in a timeline. For example, based on rule-conditions and applied-rules in an MO, an action or application may be mapped or associated with a specific moment in a day based and/or based on context or value to an end-user. For example, actions such as “Book a flight” and “Book a hotel” may be highly relevant to a time (or moment) in which a user is interested in booking a vacation. For example, an applied-rule may associate the term “travel” in a user's MO with an application for searching for flights or hotels upon detecting the user is using a search engine to search for information related to traveling.

In some embodiments, an SDK (e.g., element 180 in FIG. 4, or an actions' SDK (ASDK)) may be integrated within publisher applications. For example, an ASDK may provide a publisher the ability to perform applied-actions (e.g. show call to action buttons, icons and/or text) according to at least one user-moment (e.g., as defined by an MO), or according to the publisher's application's discretion. In some embodiments, the actions implementation, e.g., by an ASDK, may be “Native”, meaning that the ASDK may provide creative assets such as, but not limited to: action type, action icon action title and action banner The publisher's application may select an applied-action to perform on a user's computing device and choose how to present the applied-action on the device. For example, the application may be configured to select UI, UX, frequency of presentation, order of presentation, the context of presentation etc. According to some embodiments, the application may use at least one pre-defined template for presenting the applied-action.

In some embodiments, the publisher's application may further be configured to determine at least one rule-condition, to apply constraints on performance of at least one applied-action. For example, a publisher's mobile application which is a game, may enable an applied-action to be performed only when a predefined condition in the game is met.

Server 160 may enable a publisher to select an action type, e.g., choose which action types the publisher is interested in receiving, for example, an action type may be “predicted action”, that are based on user's moments or MOs, or an action type may be “none-predicted Action”, e.g., real-time.

If the publisher chooses a predicted action, an embodiment (e.g., SDK 180) may update the publisher's application on the client side (e.g., update an application provided by the publisher and installed on a user computing device 100), whenever an action or several actions are available, according to an analysis or understanding of user moments, e.g., based on data in MOs on computing device 100. If the publisher chooses none-predicted actions, the publisher may further ask for any specific action or a list of actions.

In some embodiment, an applied-action may include displaying on computing device 100 a shortcut, pointer or reference for displaying a list of applications that can be used, by the user, for completing the desired action. Once an applied-action was displayed to the user and selected by them, an embodiment may display on computing device 100a list of relevant applications to choose from.

Applications may be associated with user-moments. For example, by tracking or monitoring applications executed on a user's computing device 100, as well as the context in which the applications are run (e.g., what the user is doing now and what applications the user is executing or using) an embodiment may determine the relevance of applications to specific user-moments, e.g., through both machine learning and human association.

In some embodiments, a plurality of applications may initially be assigned to relevant applied-action, e.g., based on predefined applied-rules or manually. Once enough applications are assigned to each action, the server may check for mutual connections between the applications assigned to each applied-action. According to some embodiments, the server may perform a machine learning (ML) algorithm, on at least one clustering model, that is configured to cluster applications according to predefined criteria, including for example: the profile of users who have installed the applications, the description of applications in app-stores, the context at which users launch or use the applications, etc.

According to some embodiments, server 160 may be configured crawl the application stores, on a regular basis, for analyzing the application context from the application description, and find additional applications with similar connections. According to some embodiments, server 160 may be configured to associate the additional applications with clusters of at least one application-cluster. In some embodiments, ASDK may be configured to perform at least one applied-action associated with the additional applications. For example, ADSK may present to the user on computing device 100 notifications for relevant additional actions.

An embodiment may tag applications with relevant user-moments, and each tag may be assigned with a “match index”, according to the level of relevance to the user-moments. The match index may be defined according to a predefined list of criteria, including at least one of: application, user-action and user-action context (e.g.: location and timing of the user-action). For example, a specific application may be associated with a specific action based on a location where a service is provided.

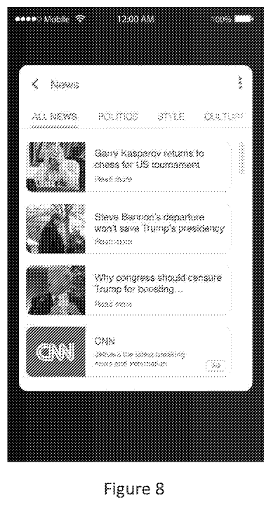

In some embodiments, when a publisher requests an action (e.g., an application of the publisher on a user's device requests an action) SDK 180 or an ASDK may send a request to server 160, and server 160 may return to SDK 180 or ASDK: (i) a list, including at least one application that matches or is associated with the requested action; and/or (ii) a list including at least one element containing relevant content, including for example: a product, media content, content of at least one web page (e.g.: news, e-commerce, etc.), or a link thereto. Reference is made to FIG. 8, depicting an exemplary list of tagged elements, as presented on a user's computing device, according to some embodiments. In this example, a list of news items may be presented on a user's smartphone after, for example, the processor has identified that a user may be interested in obtaining the outbreaking news.

Server 160 may respond to each applied-action request with a list of applications that are relevant to the requested action, including for example: products, media content, data pertaining to websites (e.g.: news, e-commerce, etc.), or a link thereto. For example, when the

Action “book a taxi” is requested, server 160 may return applications that are relevant for booking a taxi, as shown in the example depicted in FIG. 7B. The list of applications, per action provided by server 160 may include promoted applications, from campaign opened by advertisers, and that are targeting the specific action, and/or the list may include “organic applications” (e.g., applications that are not promoted but still highly relevant to the requested action). Another example: when the user clicks “Watch a movie” the server will return a TV or movie content (organic or/and promoted).

In some embodiments, after receiving the list of actions and applications per action from server 160, SDK 180 or an ASDK may check what applications are installed on the device, which of them are relevant to what action, and SDK 180 or an ASDK may compile a list of final applications to show to the user, e.g., according to the following order: promoted applications that are installed on the device, promoted applications that are not installed on the device, applications that are installed on the device and organic applications that are no installed on the device. In case of content provided to SDK by the server, the server may check which content is relevant to the user based on the user's preferences, engagement history or any other data provided by third party that may be relevant in order to identify the user preferences.

Promoted applications may include a custom message, or custom promotion/incentive aimed for the specific user. For example, referring to the “order a taxi” example, when a user clicks the call to action for ordering a taxi, an ASDK may display a list of applications that can be used to complete that action of calling a taxi. Next to each one of the promoted applications a custom message may be presented, e.g., a message generated by an advertiser for the specific user, in real time, e.g., the message may be generated based on a profile, based on the advertiser's familiarity with the user, based on a timeline and/or based on MOs created and maintained for the user.

An embodiment (e.g., server 160 or SDK 180) may communicate to advertisers, e.g., at the pre-impression stage, any relevant data for an action, for example, SDK 180 may inform an advertiser of a user's location, user's state, user destination etc. In addition, the ASDK can communicate with servers in order to receive relevant content stored on the server after acquired from third parties.

An advertiser's server may reply with a custom offer, for example: taxi “x” will arrive to your location in “x” minutes. Any other data or information may be included in a reply from an advertiser's server, e.g., a custom Deep Link URL as known in the art and/or web URL. An embodiment may display data or message received from advertiser's server, e.g., next to the advertiser's application (promoted app) and/or content—generic or sponsored. In case there are several promoted applications, the custom offer that is represented in the message may be the differentiator between promoted and none-promoted app, and between different promoted applications.

Upon detecting an interaction with (e.g. clicking on) a promoted app, SDK 180 or an ASDK may launch the relevant application/web content (e.g., per the Deep Link URL scheme), provided by the advertiser's server, or any other server (e.g., server 160). A Deep Link URL may open the application with the custom content according to the promotion displayed.

An embodiment, e.g., SDK 180 may notify a publisher, e.g., via callback on the client side, that it is ready to show the applications per action. Once the publisher (or publisher's application) receives the callback, it may show the user a call to action for the desired action (e.g., in the form of a button, icon or text, or using a method selected by an advertiser), and once the user clicks the call to action, SDK 180 or an ASDK may display the list of applications/content relevant to the action clicked (in the order specified above).

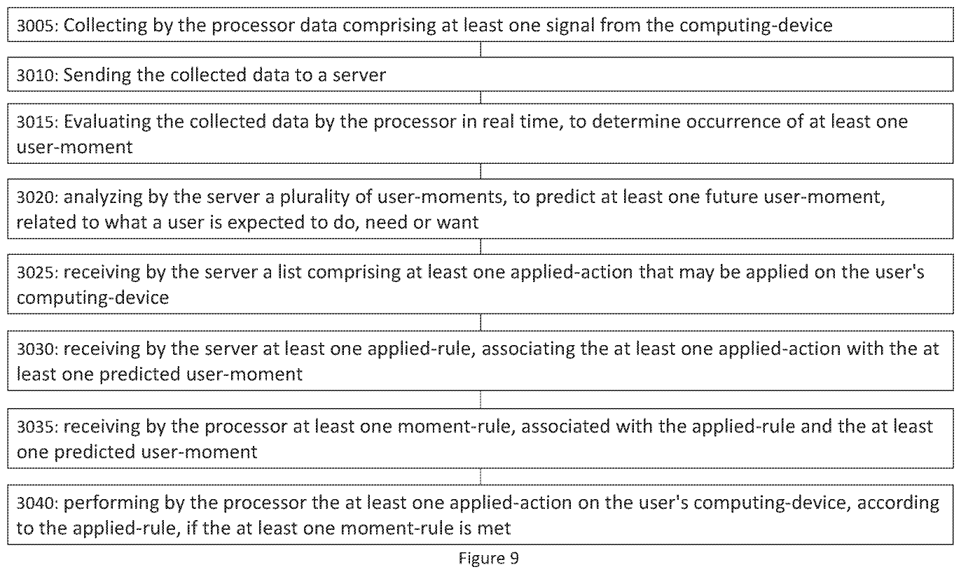

Reference is made to FIG. 9, depicting a flow diagram of a method for performing at least one applied-action on a user's computing-device, associated with a processor, according to at least one user-moment, according to some embodiments. The method includes the steps of:

Collecting by the processor data comprising at least one signal from the computing-device (S3005);

Sending the collected data to a server (S3010);

Evaluating the collected data by the processor in real time, to identify occurrence of at least one user-moment (3015);

Analyzing by the server a plurality of user-moments, to predict at least one future user-moment, related to what a user is expected to do, need or want (3020);

Receiving by the server a list comprising at least one applied-action that may be applied on the user's computing-device (3025);

Producing by the server at least one applied-rule, associating the at least one applied-action with the at least one predicted user-moment (3030);

Receiving by the processor at least one moment-rule, associated with the applied-rule and the at least one predicted user-moment (3035); and

Performing by the processor the at least one applied-action on the user's computing-device, according to the applied-rule, if the at least one moment-rule is met (3040).

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for performing at least one applied-action on a user's computing-device, associated with a processor, according to at least one user-moment, method including:
collecting by the processor data comprising at least one signal from the computing-device;
sending the collected data to a server;
evaluating the collected data by the server in real time, to determine occurrence of at least one user-moment;
analyzing by the server a plurality of user-moments, to predict at least one future user-moment, related to what a user is expected to do, need or want;
receiving by the server a list comprising at least one applied-action that may be applied on the user's computing-device;
receiving by the server at least one applied-rule, associating the at least one applied-action with the at least one predicted user-moment;
receiving by the processor at least one moment-rule, associated with the applied-rule and the at least one predicted user-moment; and
performing by the processor the at least one applied-action on the user's computing-device, according to the applied-rule, if the at least one moment-rule is met.

2. The method according to claim 1, wherein the plurality of user-moments originates from a plurality of user computing-devices, and wherein analyzing the plurality of user-moments to predict at least one future user-moment is performed by a server, associated with the plurality of computing-devices.

3. The method according to claim 2, further comprising analyzing the plurality of user-moments from a plurality of user computing-devices, to create at least one user profile, wherein said profile is associated with at least one user's computing device, and comprising at least one user-moment that is a predicted user-moment, and at least one indication related to the user's preferences.

4. The method according to claim 3, further comprising collecting by the processor data comprising a plurality of signals from the computing-device, wherein at least one signal is associated with a score, and wherein evaluating the collected data by the processor to determine at least one user-moment further comprises combining said data signals according to said scores.

5. The method according to claim 4, further comprising:
receiving at least one applied-action from a third-party, said applied-action is associated with a predefined profile;
comparing at least one user's profile with the predefined profile; and
performing the applied-action on the user's computing device when a match between the predefined profile and user-profile is found.

6. The method according to claim 5, further comprising: clustering a plurality of user-profiles in a cluster model; associating specific users with user-moments pertaining to user-profiles of other users within the same cluster; continuously adjusting at least one clustering model, based on data-signals received as feedback from at least one users' computing device; and adjusting at least one applied-rule according to the adjustment of the clustering model, to improve the user's responsiveness to applied-actions.

7. The method according to claim 1, wherein said applied-action on the user's computing device is selected from a list comprising at least one of:
invoking a specific application;
presenting a link to at least one web site;
presenting a list of icons, comprising at least one icon associated with an application installed on the computing device;
presenting a list of icons, comprising at least one icon associated with an application installed on an online application store; and
presenting an advertisement.

8. The method according to claim 4, further comprising:
acquiring by the server feedback information from at least one user's computing device, including at least one of: a history of user-moments, a history of the user's recorded interests, a history of a user's application usage, and a history of the user's preferences; and
analyzing the feedback data to determining the relevance of applied-actions from the list of applied-actions;
performing an applied-action according to said determined relevance; and
updating at least one of a profile, applied-rule, rule-condition, moment-rule and score respective of a user, according to said analysis.

9. The method according to claim 8, wherein the feedback information may further comprise at least one of personal data relating to the user, and information relating to the user's device, and wherein updating the user's profile is done according to feedback acquired from a plurality of users.

10. The method according to claim 1, wherein data associated with at least one user-moment is sent from a computing-device to the server, and wherein sending the data is triggered according to a predefined, identified user-moment event.

11. The method according claim 4, wherein said collecting of data on the user's computing-device is performed by at least one first Software Development Kit (SDK) installed therein, and wherein evaluating the data on the user's computing-device is performed by at least one second SDK installed therein, and wherein performing of at least one applied-action on the user's computing-device is performed by at least one third SDK installed therein.

12. The method according to claim 11, wherein at least two of the first, second and third SDKs are the same SDKs.

13. The method according to claim 11, wherein the at least one of first, second and third SDKs are integrated within a third-party application installed on the user's computing-device.

14. The method according to claim 11, wherein the third-party application is a native mobile app, and wherein the at least one third SDK is associated with a plurality of applied-actions, and wherein the at least one third SDK is further configured to perform at least one of:
receive from the third-party mobile application a selection of an applied-action of the plurality of applied-actions;
receive from the third-party mobile application at least one creative asset;
receive from the third-party mobile application at least one second rule-condition; and
perform the selected applied-action on the computing-device according to at least one of: the applied-rule, the first rule-condition, the second rule-condition, and the at least one creative asset.

15. The method according to claim 14, wherein the at least one creative asset is selected from a list comprising: an applied-action type, an applied-action icon, an applied-action action title, an applied-action banner, a predefined UI, a predefined UX, timing of presentation, order of presentation, and context of presentation.

16. The method according to claim 11, wherein a plurality of SDKs are integrated within a respective plurality of applications installed on a computing device, and wherein each SDK is configured to collect data on the user's computing-device according to access permissions attributed to a respective application, and wherein the server is configured to determine which SDK in the computing-device has access to what data and control each SDK's data signal collection accordingly.

17. The method according to claim 1, further comprising:
associating a plurality of third-party applications with one applied-action;
counting by the server the number of applications that are associated with the applied-action;
checking for at least one mutual connection between applications that are associated with the applied-action;
periodically crawling an online application store, for analyzing the description of applications in the application store;
finding at least one additional application with similar connections according to the analysis; and
presenting on the computing device notifications for the additional application.

18. The method according to claim 1, further comprising:
tagging at least one element with a tag respective to at least one user-moment, wherein said element is selected from a list comprising at least one of: an application, a product, media content, a link, and content of a web page;
identifying an occurrence of the at least one user-moment; and
presenting on the user's computing device a list comprising at least one element that is tagged with the tag respective to the at least one user-moment.

19. The method according to claim 3, further comprising presenting to a user on their computing device at least one message in real time, according to the user's profile, and at least one user-moment.

20. A system for performing at least one applied-action on a user's computing-device, according to at least one user-moment, system comprising:
At least one non-transitory memory device, on which modules of instruction code are stored;
a processor associated with the at least one non-transitory memory device, and configured to execute said instruction code,
wherein when executing said instruction code the processor is further configured to
collect data comprising at least one signal from the computing-device;
evaluate the collected data in real time, to determine occurrence of at least one user-moment;
analyze a plurality of user-moments, to predict at least one future user-moment, related to what a user is expected to do, need or want;
receive a list comprising at least one applied-action that may be applied on the user's computing-device;
receive at least one applied-rule, associating the at least one applied-action with the at least one predicted user-moment;
receive at least one moment-rule, associated with the applied-rule and the at least one predicted user-moment; and
perform the at least one applied-action on the user's computing-device, according to the applied-rule, if the at least one moment-rule is met.
